(19) United States
(12) Patent Application Publication
(10) Pub. No.: US 2007/0027814 A1
(43) Pub. Date: Feb. 1, 2007

(54) Transferring content between digital rights management systems

(76) Inventor: Samuli Tuoriniemi, Oulu (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/557,217

(22) PCT Filed: May 15, 2003
(86) PCT No.: PCT/IB03/01886

§ 371 Date: Nov. 15, 2005

(51) Int. Cl. G06Q 99/00

(52) U.S. Cl. 705/59

(57) ABSTRACT

A method, system and computer program product are shown for transferring encrypted content (1) and a corresponding license (4) that are contained in a first device (3) that uses a first Digital Rights Management (DRM) system of a first or second type to a second device (7) that uses a second DRM system of a first or second type, wherein the encrypted content (1) obeys a content format of the first DRM system; wherein the corresponding license (4) obeys the Rights Expression Language of the first DRM system; wherein one of the devices (3) provides an Application Programming Interface (API) (6) for importing and/or exporting the encrypted content (1) and the corresponding license (4); and wherein the other device (7) provides an application (8) for transferring (13, 14) the encrypted content (1) and the corresponding license (4).

### FIELD OF THE INVENTION

The invention relates to a method for transferring encrypted content and a corresponding license that are contained in a first device that uses a first Digital Rights Management (DRM) system of a first or second type to a second device that uses a second DRM system of a first or second type, wherein said encrypted content obeys the content format of said first DRM system; and wherein said corresponding license obeys the Rights Expression Language (REL) of said first DRM system.

### BACKGROUND OF THE INVENTION

Operators of mobile radio networks and content providers have already started selling content such as ringing tones and icons for the personalisation of a user's mobile phone as well as small video clips and computer games for information and pastime. Downloading of ringing tones and logos over the air interface of the mobile radio network was already a 1.5 Billion Euro business in Europe in the year 2000, and is expected to further grow in particular with respect to future more sophisticated audio/ringing tone formats, the enhanced transfer possibilities offered by the Multimedia Messaging Service (MMS) and the development of more advanced mobile multimedia terminals.

In the case of ringing tones, the mobile operator presently acts as the payment collector, offering its billing platform for multiple content retailers. Content such as a downloaded ringing tone is generally protected with a “forward-lock”, i.e. it can only be used on the mobile phone it was downloaded to (and where it was paid for) and cannot be transferred to another mobile phone. This simplest approach of “Digital Rights Management” (DRM) is termed delivery control. The alternative control mechanism, when the forward-lock is removed, is “usage control”. Usage rights for content are then expressed in mobile rights vouchers, created and distributed separately from the content objects. The payment is collected against the issued vouchers. Now the control point lies in the mobile phone middleware. The user requires both the content object and referring vouchers to be present before executing or storing the downloaded media. It is the great advantage of usage control that content may be superdistributed among a large community of mobile phone users by peer-to-peer communication. Content, when once downloaded, can be forwarded to other mobile phones, where before rendering the content, a mobile rights voucher has to be purchased by the user.

The key components for a DRM system that is capable of managing a content retail system based on usage control are:

A Voucher Server (VS) that may be hosted by a content retailer or an operator in the role of a content retailer. The VS registers the content to the mobile DRM system and issues vouchers.

A Content Server (CS) is hosted by the content retailer or its content partners if it operates in aggregation mode. The CS includes the downloadable content.

A DRM Broker is hosted by the payment collector, which may be an operator. The Broker is effectively a “rights-clearing feature” in the mobile payment solution with interfaces to payment systems.

The content retailer (the VS and CS owner) makes a payment and rights clearing agreement with the operator (the owner of the DRM broker), agreeing to pay a certain percentage on each transaction cleared. The content retailer's VS keeps track of all the unique content it puts into circulation. The CS owner must register each content object that they want to import into the mobile DRM system. Content registration means, in essence, that the CS ships the content object to the VS, which creates a unique content ID and encrypts the content into a DRM specific content package. The whole process of encrypting the content and generating vouchers (licenses) for the encrypted content obeys the DRM system's Rights Expression Language (REL).

The browsing and downloading of registered content takes place directly between the CS and the consumer, regardless of the voucher purchase process. Once downloaded, the registered content may flow freely from terminal to terminal. When the user tries to render registered content, the terminal will check whether there is a voucher with referring content ID in the terminal. If there is not such a voucher, the terminal will initiate a payment and rights clearing process with a payment service provider.

The voucher purchase is carried out through the DRM Broker, based on the VS address. Once the consumer agrees to pay, the DRM broker clears the payment and asks for a voucher from the VS. The rights clearing process is completed as the DRM broker forwards the voucher generated by the VS to the user.

A DRM system for controlling the rendering of a protected piece of digital content on a computing device is disclosed in WO 00/058811 A2. The DRM system has a license (voucher) store, a license evaluator and a state store. The license store stores purchased digital licenses on the computing device. The license evaluator determines whether any licenses stored in the license store correspond to the requested digital content and whether any such corresponding licenses are valid, reviews license rules in each such valid license, and determines based on such reviewed license rules whether such license enables the requesting user to render the requested digital content in the manner sought. The state store maintains state information corresponding to each license in the license store, where the state information is created and updated by the license evaluator as necessary.

### SUMMARY OF THE INVENTION

State-of-the-art DRM systems are based on the assumption that rendering of digital content shall be limited to the terminal the voucher was downloaded to. However, if a user possesses several terminals and wants to render the digital content that he already has paid for on two or more of these terminals, wherein each of these terminals is controlled by a DRM system, he is forced to purchase further vouchers for each of the terminals the content is to be rendered on. Even worse, if the DRM system run by the terminals are mutually incompatible, it is not possible to transfer the content between the terminals at all, because the DRM system of a terminal may not be able to decrypt the content and may not be able to identify the DRM broker by which the corresponding voucher can be purchased.

In view of this disadvantage of the state-of-the-art DRM systems, it is thus the object of the invention to provide a method for transferring content between DRM systems.

The object of the invention is solved by proposing that a method for transferring encrypted content and a corresponding license that are contained in a first device that uses a first Digital Rights Management (DRM) system of a first or second type to a second device that uses a second DRM system of a first or second type, wherein said encrypted content obeys the content format of said first DRM system; wherein said corresponding license obeys the Rights Expression Language (REL) of said first DRM system; wherein one of said devices provides an Application Programming Interface (API) for importing and/or exporting said encrypted content and said corresponding license; and wherein the other device provides an application for transferring said encrypted content and said corresponding license; comprises the steps of establishing a connection between both devices, granting said application access to said API, and transferring said encrypted content and said corresponding license from the first to the second device by said application and via said API. Once the connection between both DRM systems is established physically and logically, the operating system of the device that provides the API grants the application provided by the other device access to its import/export functionality, and the transfer of encrypted content and corresponding licenses can be performed by the application. Transfer of content and licenses can either take place from the device that provides the API to the other device or vice versa. It is also possible that both devices provide said API and/or that both devices provide said application.

For instance, the device that provides the application can then be used as an intermediate storage device in the transfer of encrypted content and a corresponding license from a source terminal, e.g. a mobile phone, to a target terminal, e.g. a mobile phone or a multi-media player. The content that has been encrypted according to the content format of the first DRM system that is used by the source terminal and the corresponding license (voucher) that has been purchased from the VS via the DRM broker in order to be able to render the encrypted content on the source terminal (the first device) are transferred to the intermediate storage device (the second device) that uses its own DRM system (the second DRM system). The transfer is performed by the application provided by the intermediate storage device and uses the API provided by the source terminal. In an anew transfer, the encrypted content and corresponding license is then transferred from the intermediate storage device (now the first device) to the target terminal (now the second device), which also runs its own DRM system. Again, the transfer is performed by the application provided by the intermediate storage medium and uses the API that is now provided by the target terminal. Thus the source and target terminals in both transfers represent the device that provides the API, and the intermediate storage device in both transfers represents the device that provides the application for transferring encrypted content and corresponding licenses.

According to the present invention, it is preferred that the method further comprises the step of verifying the integrity of said application and granting said application access to said API only in case of verified integrity. To prevent pirate use of the application, access of the application to the otherwise protected functionality of the API is only granted to the application if its integrity has been verified.

According to the present invention, it is advantageous if the method further comprises the step of storing said encrypted content and said corresponding license in the second device.

Said first and second device may both be contained in one apparatus, e.g. an electronic device that consists of several aggregated components such as a mobile phone and a multi-media player.

According to the present invention, said first and second DRM system may be of the same type. Both DRM systems are then compatible, and the encrypted content and the corresponding license may be passed between both DRM systems without any modification.

Alternatively, said first DRM system may be of a first type and that said second DRM system may be of a second type. Both DRM systems then are incompatible with each other, and the transferred encrypted content and the corresponding license have to be further processed in order to allow rendering of the content on the second device.

According to the present invention, it may be preferred that the method further comprises the step of modifying said license in either the first or second device. After transfer of the encrypted content and the corresponding license from a first device to a second device, the license in the first DRM system of the first device then may for instance be modified in a way that further transfer of the content is possible, but that the transfer of the license from the first device to a third device is no longer possible. It may also be imagined that after each transfer, the license in the first device is deleted, so that rendering of encrypted content is only possible on one device at a time.

In the case that the first DRM system is of a first type and the second DRM system is of a second type, it is preferred that said step of transferring said encrypted content and said corresponding license from the first to the second device by said application and via said API cqmprises the steps of transcoding said license for said encrypted content from the REL of the first DRM system to the REL of the second DRM system, and transcrypting said encrypted content from the content format of the first DRM system to the content format of the second DRM system. The encrypted content is thus decrypted according to the content format of the first DRM system, and subsequently encrypted according to the content format of the second DRM system (transcrypted). Quite similar, the license is decoded according to the REL of the first DRM system, and subsequently encoded according to the REL of the second DRM system (transcoded). Together with the transcoded license, the transcrypted content can then be rendered by or used in the second device that uses the second DRM system, although the first and second DRM system are basically incompatible. The transcrypted content and transcoded license, that now obey the content format and REL of the second DRM system, respectively, are then stored on the second device.

According to the present invention, said device that provides that API may be a multi-media device such as a mobile phone, a media player or a personal digital assistant, and said device that provides the application may be a mass storage medium that may be inserted in said device that provides the API or connected to said device that provides the API by means of a wired or wireless link.

The object of the invention is further solved by a computer program product directly loadable into the internal memory of a digital computer, comprising software code portions for performing the above-described method steps when said product is run on a computer. Said digital computer may for instance be represented by a micro-processor that is part of one of said devices.

The object of the invention is further solved by a system for transferring encrypted content and a corresponding license that are contained in a first device that uses a first Digital Rights Management (DRM) system of a first or second type to a second device that uses a second DRM system of a first or second type, wherein said encrypted content obeys the content format of said first DRM system; and wherein said corresponding license obeys the Rights Expression Language (REL) of said first DRM system;

the system comprising means for establishing a connection between both devices, an Application Programming Interface (API) for importing and/or exporting said encrypted content and said corresponding license, wherein said API is provided by one of said devices, and an application for transferring said encrypted content and said corresponding license via said API, wherein said application is provided by the other of said devices.

According to the present invention, it is advantageous if the system further comprises means for verifying the integrity of said application.

According to the present invention, it is preferred that the system further comprises means for storing said encrypted content and said corresponding license in the second device.

According to the present invention, said first and second device may both be contained in one apparatus.

According to the present invention, said first and second DRM system may be of the same type.

Alternatively, said first DRM system may be of a first type and that said second DRM system may be of a second type.

The system according to the present invention may further comprise means for modifying said license in either the first or second device.

If the first DRM system is of a first type and the second DRM system is of a second type, it is advantageous if the system further comprises means for transcoding said license for said encrypted content from the REL of the first DRM system to the REL of the second DRM system, and means for transcrypting said encrypted content from the content format of the first DRM system to the content format of the second DRM system.

Said means for transcoding and transcrypting are advantageously provided by said application.

According to the present invention, said device that provides that API may be a multi-media device such as a mobile phone, a media player or a personal digital assistant, and that said device that provides the application may be a mass storage medium that may be inserted in said device that provides the API or connected to said device that provides the API by means of a wired or wireless link.

### BRIEF DESCRIPTION OF THE DRAWINGS

These and other aspects of the invention will be apparent from and elucidated with reference to the embodiments described hereinafter. In the figures show:

FIG. 1: a schematic view of an embodiment of the present invention, where encrypted content and a corresponding license are transferred from a first device with a first DRM system to a second device with a second DRM system.

### DETAILED DESCRIPTION OF THE INVENTION

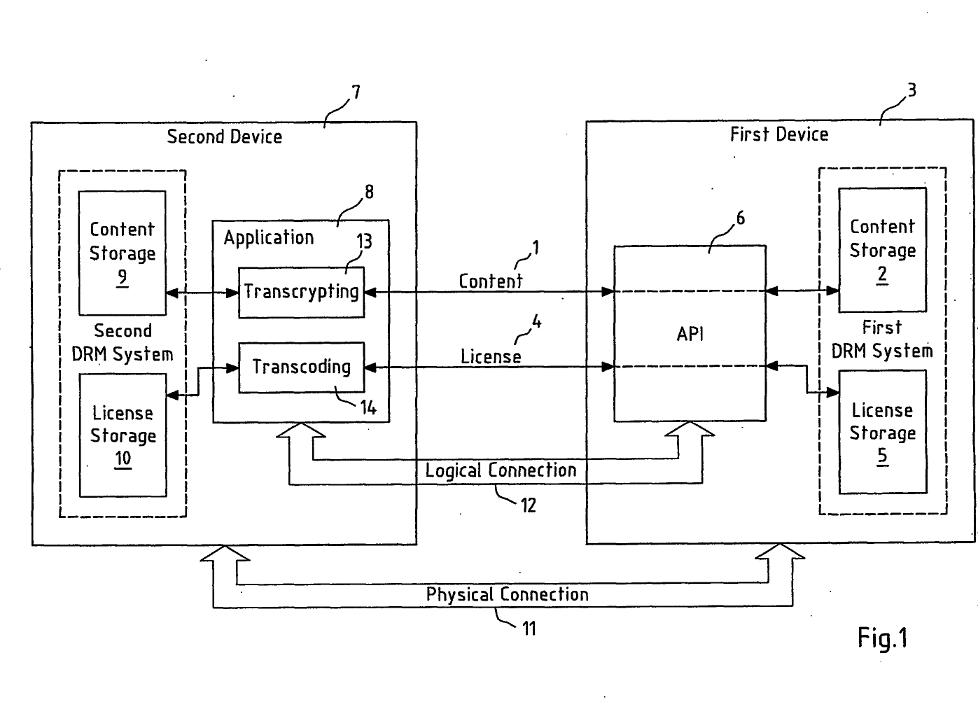

FIG. 1 depicts a schematic view of an exemplary embodiment of the present invention. Content 1 that has been encrypted by a VS according to the content format of a first DRM system has been downloaded to the content storage 2 of a first device 3. The user of the first device 3 also has purchased a license 4 in order to be able to render the content on the first device 3. The license has been generated by the VS of the first DRM system according to the system's REL and is stored in the license storage 5. If the content 1 is to be rendered on the first device 3, a license evaluator, which is not depicted in FIG. 1, checks whether the license storage 5 contains any license that allows the user of the first device 3 to render the content 1. The first device 3 provides an API 6 that can be used to import and/or export content 1 and license 4 and grants access to otherwise protected functionality.

FIG. 1 also shows a second device 7, which contains an application 8. This second device 7 can be imagined as a mass storage medium, e.g. a memory card or stick, that contains the application 8 as executable code or source code and is suited for taking over the content 1 and license 4 from the first DRM system that is used by the first device 3. To this end, the second device provides a content storage 9 and a license storage 10. When the second device 7 is physically connected with the first device 3, e.g. by means of a physical wrap connection 11, the operating system of the first device 3 verifies the integrity of application 8 that is contained in the second device 7 and checks if it can grant the application 8 access to the first device's API 6 by means of a logical secure connection 12. During the set-up of the logical secure connection 12, the application and the first DRM system's DRM agent perform mutual authentication and also verify that the counterpart has not been revoked. When the logical secure connection 12 has been established, the application 8 requests the content 1 and license 4 from the content storage 2 and license storage 5 of the first DRM system.

Depending on the type of the second DRM system that is used by the second device 7, the content 1 has to be transcrypted in a transcryption instance 13 before storage in the content storage 9 and the license has to be transcoded in a transcoding instance 14 before storage in the license storage 10. Only if the second DRM system and the first DRM system are equal, no transcoding and transcrypting is necessary. The step of transcrypting comprises the steps of decrypting the content that has been encrypted by the VS of the first DRM system according to the first DRM system's content format, and encrypting it according to the second DRM system's content format. Quite similar, the step of transcoding comprises the steps of decoding the license that has been coded by the VS of the first DRM system according to the first DRM system's REL, and coding it according to the second DRM system's REL. For the transcryption and transcoding process, both knowledge of the structure of the encryption and the license codes is necessary, i.e. both operations have at least to some extent be authorised by the content retailer as owner of the intellectual property rights of the content. The content 1 and corresponding license 4 thus have been successfully transferred from the first device 3, where they were downloaded to, to the second device 7. When the second device 7 is a simple memory card inserted into the first device 3, where the memory card 7 possesses only simple transcoding/transcryption and storing capabilities, rendering of the content is not possible on the second device 7. However, the memory card 7 may be removed from the first device 3 and inserted into a third device, e.g. a multi-media player. The content and license transfer is then performed vice-versa from the memory card 7 to the third device. Note that, when the DRM system of the third device, i.e. the third DRM system, is not the same DRM system as used on the memory card 7, in the transfer of the content 1 and license 4 from the memory card 7 to the third device further transcryption and transcoding is required, i.e. the transcoding and transcryption instances then also require knowledge on the encryption and license code structure of the third DRM system. However, when the content 1 and license 4 have been transferred to the third device, the license evaluator of this third device is provided with content 1 encrypted according to the third DRM system and a corresponding license 4 and thus allows the rendering of the content 1 on the third device.

The invention has been described above by means of a preferred embodiment. It should be noted that there are alternative ways and variations which are obvious to a skilled person in the art and can be implemented without deviating from the scope and spirit of the appended claims, e.g. the transcrypting and transcoding operation can each be performed in one step instead of first decrypting and then encrypting or first decoding and then encoding again. This has the further advantage that not complete knowledge of the encryption process and license code structure has to be revealed by the content retailers, only the mathematical procedures for transcryption and transcoding from one specific DRM system to another specific DRM system are required to implement the transcryption and transcoding instances 13 and 14. It is easily understood that the second device 7 can be connected to the first device via a wireless link like a Bluetooth link or an infrared link. If the second device 7 is used as an intermediate storage medium to transfer the content 1 and corresponding license 4 from a first device 3 with a first DRM system to a third device with a third DRM system, the DRM system used on the second device 7 is advantageously either equal to the first or third DRM system to reduce the amount of transcryption and transcoding. The second device 7 does not necessarily have to be a simple memory card, it can also represent a multi-media player or a mobile phone which contains said transcoding and transcryption application and/or an import/export API. Then transfer of content 1 and corresponding license 4 can be accomplished between two mobile phones or a mobile phone and a multi-media player directly, e.g. based on a Bluethooth, infrared or cable link. The modification of the license that was purchased in the source DRM system also offers a variety of possibilities. The license may either be deleted after transfer to a second DRM system or modified in the sense of a counter, i.e. so that only a couple of further transfers of the license are possible.

1. Method for transferring encrypted content (1) and a corresponding license (4) that are contained in a first device (3) that uses a first Digital Rights Management (DRM) system of a first system type or a second system type to a second device (7) that uses a second DRM system of the first system type or the second system type, wherein said encrypted content (1) obeys a content format of said first DRM system; wherein said corresponding license (4) obeys a Rights Expression Language (REL) of said first DRM system; wherein one of said first device and said second device provides an Application Programming Interface (API) (6) for importing, or for exporting, or for both importing and exporting said encrypted content (1) and said corresponding license (4); and wherein another one of said first device and said second device provides an application (8) for transferring said encrypted content (1) and said corresponding license (4);
the method comprising the steps of:
establishing a connection (11, 12) between the first device (3) and the second device (7);
granting said application (8) access to said API (6); and
transferring said encrypted content (1) and said corresponding license (4) from the first device (3) to the second device (7) by said application (8) and via said API (6).

2. Method according to claim 1, characterized in that said method further comprises the step of verifying integrity of said application (8) and granting said application (8) access to said API (6) only in case of verified integrity.

3. Method according to claim 1, characterized in that the method further comprises the step of storing (9, 10) said encrypted content (1) and said corresponding license (4) in the second device (7).

4. Method according to claim 1, characterized in that said first device (3) and said second device (7) are both contained in one apparatus.

5. Method according to claim 1, characterized in that said first DRM system and said second DRM system are of s same system type.

6. Method according to claim 1, characterized in that said first DRM system is of the first system type and that said second DRM system is of the second system type.

7. Method according to claim 1, characterized in that the method further comprises the step of modifying said license in either the first device (3) or the second device (7).

8. Method according to claim 6, characterized in that said step of transferring said encrypted content (1) and said corresponding license (4) from the first device (3) to the second device (7) by said application (8) and via said API (6) comprises the steps of:
transcoding (14) said license (4) for said encrypted content from a REL of the first DRM system to the REL of the second DRM system; and
transcrypting (13) said encrypted content (1) from the content format of the first DRM system to a content format of the second DRM system.

9. Method according to claim 1, characterized in that said device (3) that provides said API (6) is a multi-media device such as a mobile phone, a media player or a personal digital assistant, and that said device (7) that provides the application (8) is a mass storage medium that can be inserted in said device (3) for providing the API (6) or connected to said device (3) for providing the API (6) by a wired or wireless link (11).

10. A computer program product directly loadable into an internal memory of a digital computer, comprising software code portions for performing the steps of claim 1 when said product is run on a computer.

11. System for transferring encrypted content (1) and a corresponding license (4) that are contained in a first device (3) that uses a first Digital Rights Management (DRM) system of a first system type or a second system type to a second device (7) that uses a second DRM system of the first system type or the second system type, wherein said encrypted content obeys a content format of said first DRM system; and wherein said corresponding license obeys a Rights Expression Language (REL) of said first DRM system;
the system comprising:
means for establishing a connection (1, 12) between the first device and the second device,
an Application Programming Interface (API) (6) for importing, or for exporting or for both importing and exporting said encrypted content (1) and said corresponding license (4), wherein said API (6) is provided by one of said first device and said second device; and
an application (8) for transferring said encrypted content (1) and said corresponding license (4) via said API (6), wherein said application (8) is provided by another one of said first device and said second device.

12. System according to claim 11, characterized in that the system further comprises means for verifying integrity of said application.

13. System according to claim 11, characterized in that the system further comprises means for storing (9, 10) said encrypted content and said corresponding license in the second device.

14. System according to claim 11, characterized in that said first device (3) and said second device (7) are both contained in one apparatus.

15. System according to claim 11, characterized in that said first DRM system and said second DRM system are of a same type.

16. System according to claim 11, characterized in that said first DRM system is of a first type and that said second DRM system is of a second type.

17. System according to claim 11, characterized in that the system further comprises means for modifying said license in either the first device (3) or the second device (7).

18. System according to claim 16, characterized in that the system further comprises:
means for transcoding (14) said license (4) for said encrypted content (1) from the REL of the first DRM system to a REL of the second DRM system; and
means for transcrypting (13) said encrypted content (1) from the content format of the first DRM system to a content format of the second DRM system.

19. System according to claim 18, characterized in that said means for transcoding (14) and transcrypting (13) are provided by said application (8).

20. System according to claim 11, characterized in that said device (3) that provides said API (6) is a multi-media device such as a mobile phone, a media player or a personal digital assistant, and that said device (7) that provides the application (8) is a mass storage medium that can be inserted in said device (3) that provides the API or connected to said device (3) that provides the API by a wired or wireless link.
